(19) United States
(12) Patent Application Publication
(10) Pub. No.: US 2013/0187766 A1
(43) Pub. Date: Jul. 25, 2013

(54) Systems and Methods for Remotely Locating and Optionally Adjusting Fixtures

(71) Applicants: Benjamin Mathews, San Antonio, TX (US); Matthew Weaver, Aptos, CA (US)

(72) Inventors: Benjamin Mathews, San Antonio, TX (US); Matthew Weaver, Aptos, CA (US)

(21) Appl. No.: 13/747,294

(22) Filed: Jan. 22, 2013

Related U.S. Application Data
(60) Provisional application No. 61/589,119, filed on Jan. 20, 2012.

(51) Int. Cl. G08C 19/16

(52) U.S. Cl. CPC G08C 19/16
USPC 340/12.22

(57) ABSTRACT

Systems and methods for locating and optionally adjusting fixtures (e.g., light fixtures, audio-visual equipment, alarm systems, etc.), such as those, for example, configured to be located and/or adjusted remotely (e.g., using WiFi, GPS, radio frequency identification, Bluetooth, radio, sound, ultrasound, light, Zigbee, ultra wide band, and/or combinations thereof).

### CROSS-REFERENCE TO RELATED APPLICATIONS

This application claims priority to U.S. Provisional Patent Application No. 61/589,119 filed Jan. 20, 2012, which is incorporated by reference in its entirety.

### BACKGROUND OF THE INVENTION

1. Field of the Invention

Systems and methods for locating and optionally adjusting fixtures (e.g., light fixtures, audio-visual equipment, alarm systems, etc.), such as those, for example, configured to be located and/or adjusted remotely (e.g., using WiFi, GPS, radio frequency identification, Bluetooth, radio, sound, ultrasound, light, Zigbee, ultra wide band, and/or combinations thereof).

2. Description of Related Art

Examples of systems and methods for remote positioning of devices are disclosed in U.S. Pat. Nos. 7,129,891 and 8,073,467 and in U.S. Patent Publication No. 2009/0184837.

Fixtures can be adjusted in various ways. For example, fixtures can be adjusted manually using gears that allow a user to adjust the fixtures (e.g., with a screwdriver). However, it is not always easy or desirable to adjust a fixture manually. DMX512 provides another manner of adjusting fixtures. DMX512 uses differential signaling, along with a variable-size, packet-based communication protocol. Although, DMX512 can be uni-directional and may not include automatic error checking and/or correction. Further, false triggering can occur from electromagnetic interference, static electricity discharges, improper cable termination, excessively long cables, poor quality cables, and the like.

DMX512 wireless adapters can sometimes alleviate issues with excessively long or poor quality cables. A wireless adapter can include a controller with a wireless transmitter and a receiver near fixtures to convert the wireless signal to DMX512 wired network signals. DMX512 wireless systems can use WLAN technology, frequency-hopping spread spectrum (FHSS) technology to attain more reliable data transfers, and/or adaptive frequency-hopping and cognitive coexistence. However, the functionality of DMX512 wireless adapters can be limited by distance. Further, DMX512 can be prohibitively expensive and complicated. In addition, DMX512 relies on DMX protocol to determine position.

Various ways exist to determine location (relative or absolute). For example, the Global Positioning System (GPS) can determine a location or position. However, GPS cannot always accurately report location, for example, in urban environments and/or within a building or home. Another example of a position-determining method is based on WiFi access points in a given area (e.g., by signal strength, WiFi triangulation, etc.). WiFi can be limiting, however, because it cannot always function adequately over long distances. Therefore, a particular position-determining method could be more or less desirable based on the circumstances (e.g., whether a user is outside or inside, whether a user is in an urban or rural environment, cost, availability, ease of use, etc.).

### SUMMARY

Some embodiments of the present systems for remotely adjusting a fixture comprises at least one fixture and a control device configured to interface with the at least one fixture and further configured to: determine a position of the at least one fixture, provide a display of the at least one fixture on a map, and permit a user to adjust the at least one fixture with the display. In some embodiments, the system further comprises a first positioning device, a second positioning device, a third positioning device, and a fourth positioning device, where the first positioning device, the second positioning device, the third positioning device, and the fourth positioning device are configured to interface with the control device such that the control device can determine the position of the at least one fixture. In some embodiments, the at least one fixture comprises an identifier and the control device is configured to identify the at least one fixture with respect to other objects based on the identifier. In some embodiments, the system is configured to determine the position of the at least one fixture with GPS, WiFi, Bluetooth, radio frequency identification, ultra wide band, radio, sound, ultrasound, Zigbee, light, infrared, or a combination thereof. In some embodiments, the at least one fixture is at least one of audio-visual equipment, a light, a television, a radio, a speaker, a sprinkler, an alarm system, and other suitable devices.

Some embodiments of the present systems for remotely adjusting a fixture comprises a plurality of fixtures and the control device is configured to determine a position of each fixture with respect to a position of other fixtures. In some embodiments, the control device is at least one of a computer, mobile phone, and a tablet. In some embodiments, the map is further configured to display a position of the control device. In some embodiments, the control device is further configured to determine an orientation of the at least one fixture. In some embodiments, the control device is configured to permit a user to adjust the position and the orientation of the at least one fixture. In some embodiments, the map displays a geographic area in which the system is located. In some embodiments, when the at least one fixture is a light, the control device is configured to permit a user to adjust brightness of the light. In some embodiments, when the at least one fixture is a light, the control device is configured to permit a user to adjust a color of the light. In some embodiments, the control device is configured to determine the position of the at least one fixture based on at least one of WiFi, GPS, radio frequency identification, Bluetooth, radio, sound, ultrasound, light, Zigbee, and ultra wide band. In some embodiments, a first fixture in the plurality of fixtures is configured to interface with a second fixture in the plurality of fixtures such that a user can replicate an adjustment of the first fixture to the second fixture.

Some embodiments of the present methods comprise disposing four positioning devices in a geographical area, using the positioning devices, determining a position of at least one fixture, displaying a map of the position of the at least one fixture on a control device, and adjusting the at least one fixture using the map displayed on the control device. In some embodiments, the at least one fixture is a light fixture. In some embodiments, the method further comprises adjusting a brightness of the light fixture with the control device. In some embodiments, the method further comprises adjusting a color of the light fixture with the control device. In some embodiments, the method further comprises replicating an adjustment of the at least one fixture to another fixture.

Any embodiment of any of the present systems and methods can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The term “coupled” is defined as connected, although not necessarily directly, and not necessarily mechanically; two items that are “coupled” may be unitary with each other. The term “a” and “an” are defined as one or more unless this disclosure explicitly requires otherwise. The terms “substantially” is defined as largely but not necessarily wholly what is specified (and includes what is specified; e.g., substantially 90 degrees includes 90 degrees and generally parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. A method that “comprises,” “has,” “includes” or “contains” one or more steps possesses those one or more steps, but is not limited to possessing only those one or more steps.

The feature or features of one embodiment may be applied to other embodiments, even though not described or illustrated, unless expressly prohibited by this disclosure or the nature of the embodiments. Details associated with the embodiments described above and others are presented below.

Further, a system or method, or a component of such system or method, that is configured in a certain way is configured in at least that way, but it can also be configured in other ways than those specifically described.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a top view of one embodiment of the present systems to remotely control and optionally adjust fixtures.

FIG. 2 depicts one embodiment of a display of a control device of the present systems.

FIG. 3 depicts one embodiment of positioning devices disposed in a geographic area.

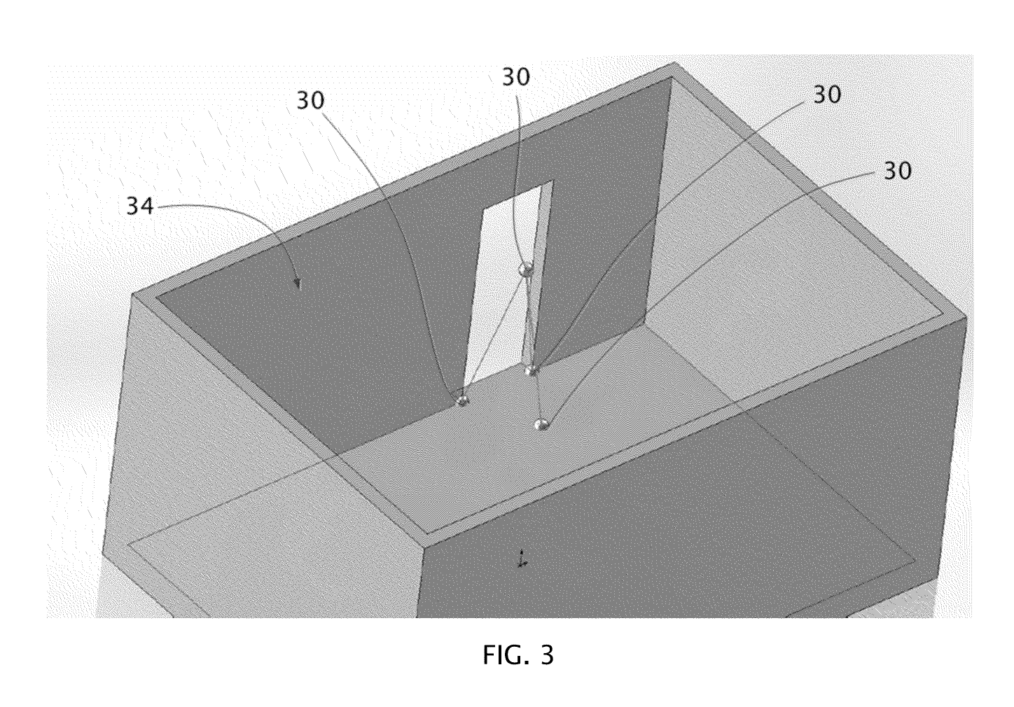

### DESCRIPTION OF ILLUSTRATIVE EMBODIMENTS

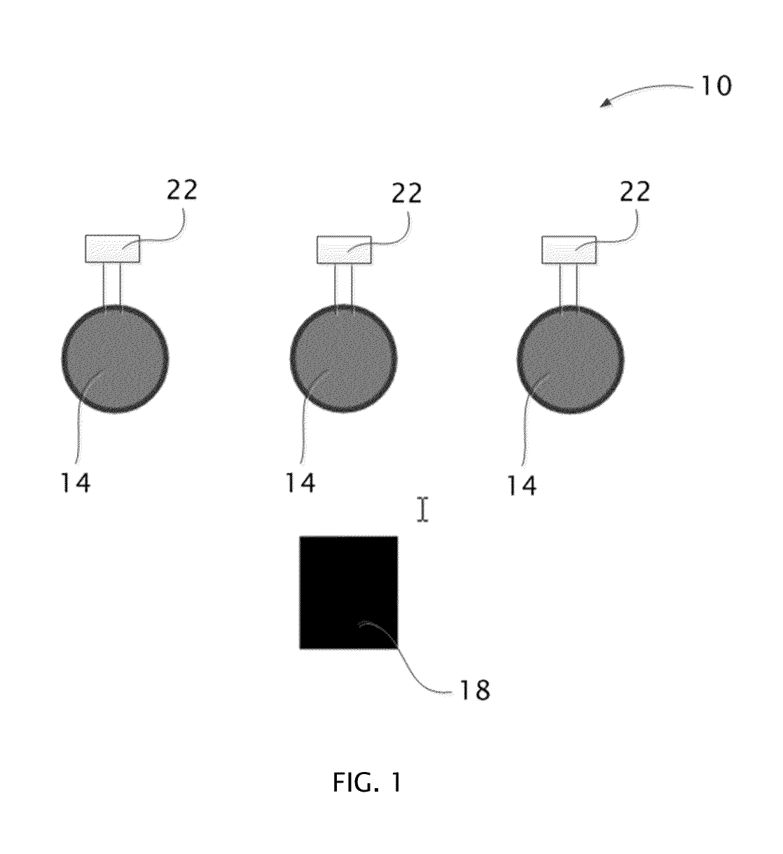

Embodiments of the present systems and methods to remotely adjust fixtures are described herein. FIG. 1 depicts one embodiment of the present systems 10. In the embodiment shown, system 10 comprises at least one fixture 14 (e.g., light fixtures, recessed down light fixtures, fans, fog machines, speakers, and similar items). In some embodiments, system 10 comprises a plurality of fixtures 14 (e.g., two, three, four, five, six, or more fixtures). In some embodiments, fixtures 14 can have a fixed physical location (e.g., mounted in a ceiling) and can be non-adjustable. In other embodiments, fixtures 14 can have a fixed physical location and can be adjustable (e.g., via adjustments to the orientation and/or position of the fixture, via adjustments to the function of a fixture (e.g., brightness, color, and volume), and the like). In other embodiments, fixtures 14 can have a movable physical location and can be either adjustable or non-adjustable.

In some embodiments, fixtures 14 can comprise positioning software. For example, the positioning software can be configured to assist in determining the position and/or orientation of fixtures 14. The positioning software can use any suitable position-determining methods, software, and/or devices (e.g., WiFi signal strength, WiFi triangulation, GPS, Bluetooth, radio frequency identification, ultra wide band, radio, sound, ultrasound, Zigbee, light, infrared, and/or a combination thereof). In some embodiments, the positioning software can be configured to determine the position of each respective fixture 14 based on the position of other fixtures 14 (e.g., a relative position). In other embodiments, positioning software can be configured to determine an absolute position of fixtures 14 (e.g., by positioning the fixtures on a map of a geographical area in which the system is located). Further, the positioning software can be configured to determine the position of each respective fixture 14 relative to other devices using, recognizing, and/or interfacing with the same or similar positioning software.

In the embodiment shown, a control device 18 (e.g., a computer, telephone, smart phone, tablet, and the like) is configured to interface (e.g., wirelessly) with one or more fixtures 14. Control device 18 can comprise software configured to receive information (actively or passively) relating to the position and/or orientation of fixtures 14. In some embodiments, control device 18 can comprise software configured to assist in determining the position and/or orientation of fixtures 14. In the embodiment shown, control device 18 can be configured to create and/or display a map (e.g., two dimensional or three dimensional) depicting the position and/or orientation of fixtures 14, control device 18, and/or other devices interfaced with control device 18 (e.g., such as the display depicted in FIG. 1) such that a user can view and/or adjust the position and/or orientation of fixtures and other devices interfaced with control device 18.

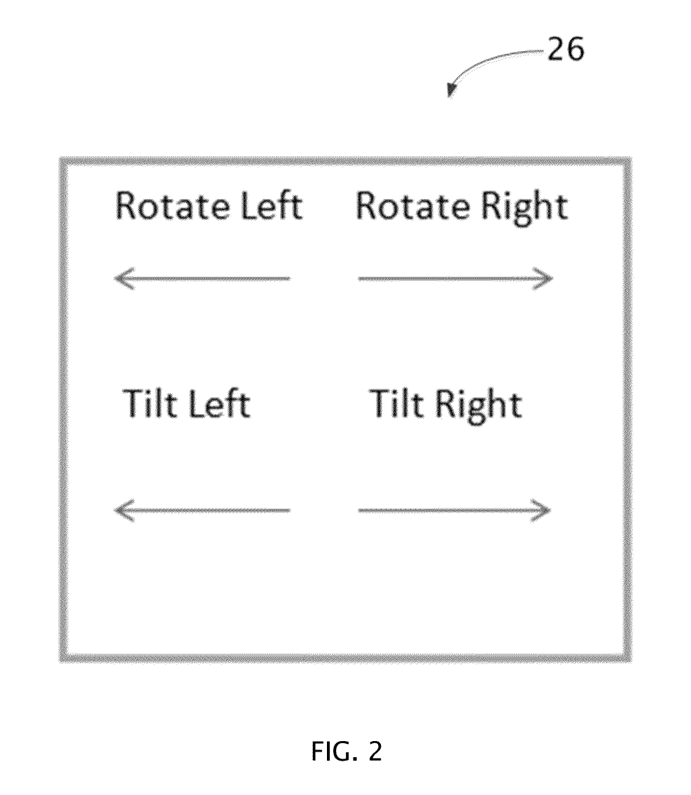

In the embodiment shown, control device 18 is configured to adjust fixtures 14. Each fixture 14 can comprise actuator 22 (e.g., a servomechanism) configured to adjust any suitable feature, component, and/or characteristic of fixtures 14 (e.g., on/off, tilt, rotation, dimming, brightness, color, speed, and/or location). Each actuator 22 can comprise (or be coupled to) a transmitter configured to broadcast a network. Fixtures 14 and/or control device 18 can be configured to connect to the transmitter network. In some embodiments, fixtures 14 can use the connection with other fixtures 14 to determine position and/or orientation. Control device 18 can be configured such that a user can adjust fixtures 14 (e.g., via the network) in any suitable way including, but not limited to, adjusting on/off, tilt, rotation, dimming, brightness, color, speed, zoom (e.g., beam angle), cut-off mask, color gel, and/or location. Display 26 of FIG. 2 depicts one example of a view that control device 18 can display to allow a user to adjust at least one fixture 14.

In some embodiments, system 10 can also operate as a performance feedback tool. For example, using the network broadcast by at least one fixture 14, at least one fixture 14 can provide data (e.g., real-time data, stored data, etc.) on fixture performance (e.g., light outages, mechanical issues, electrical issues, etc.) to a user and/or a third party. In other embodiments, system 10 can allow for partial or complete automation of fixtures 14. For example, system 10 can be configured to cross-reference GPS signals such that fixtures 14 can adjust based on the time of day (e.g., a light fixture may turn on at night, a fan may turn off in the morning, etc.).

In some embodiments, each fixture 14 can comprise an inclinometer (e.g., a solid-state two-axis accelerometer or a solid-state three-axis accelerometer) to permit control device 18 and/or fixtures 14 to determine an angle of a fixture, a slope of a fixture, and/or elevation or depression of a fixture with respect to gravity. In some embodiments, each fixture 14 can further comprise a magnetic field sensor/compass (e.g., dual antennas or triple antennas (e.g., on a non-vertical axis)) to permit control device 18 and/or fixtures 14 to determine a horizontal angle of a fixture. In other embodiments, control device 18 and/or fixtures 14 can determine a fixture's orientation relative to a known orientation of a component of a fixture (e.g., a base), such as, for example, using a marking device (discussed in detail below) and/or by incremental encoders, absolute encoders, and/or rotary potentiometers.

In some embodiments, system 10 further comprises positioning devices 30 (e.g., four positioning devices, in the embodiment shown) that can be disposed in a geographic area (e.g., geographic area 34, in the embodiment shown). In the embodiment shown, positioning devices 30 are configured to interface with control device 18 (e.g., via WiFi, GPS, Bluetooth, radio frequency identification, ultra wide band, radio, sound, ultrasound, Zigbee, light, infrared, and/or a combination thereof) such that control device 18, fixtures 14, and/or positioning devices 30 can determine the position of fixtures 14 based on information received from positioning devices 30. In the embodiment shown, positioning devices 30 are disposed in geographic area 34 such that positioning devices 30 do not share the same plane. For example, positioning devices 30 and at least one fixture 14 can be disposed in geographic area 34. A user can activate positioning devices 30 via control device 18 such that positioning devices 30 and control device 18 can determine a position of at least one fixture 14. In some embodiments, a fixture 14 can be configured to store and/or save its position (e.g., in non-volatile memory) such that fixture 14 and/or control device 18. Control device 18 can then display a map of each fixture 14 located by control device 18 and/or positioning devices 30 to permit a user to adjust each fixture 14 with control device 18. In some embodiments, after the positions of four fixtures 14 have been determined, such fixtures can assist in determining the positions of other fixtures 14 (e.g., by determining such positions, by assisting control device 18n determining such positions, by assisting positioning devices 30 in determining such positions, and the like).

In some embodiments, a user can use a marking device to determine a perimeter of a geographic area (e.g., by walking the perimeter of the room with the marking device, placing the marking device in each corner of a geographic area (if any), and the like). In some embodiments, a user can use a marking device to identify and/or determine the position of doorways, fixtures, outlets, windows, and similar objects. Control device 18 can receive information regarding a geographic area from the marking device and display such information on control device 18 (e.g., by displaying an identified fixture on a map of the geographic area, by displaying features of a geographic area on a map (e.g., windows), and the like). The marking device can also be configured to determine the orientation of the geographic area with respect to Earth (e.g., north versus south). In some embodiments, the marking device can automatically determine a nearest fixture 14 (e.g., via WiFi signal strength, WiFi triangulation, GPS, Bluetooth, radio frequency identification, ultra wide band, radio, sound, ultrasound, Zigbee, light, infrared, and/or a combination thereof). For example, a user can place positioning devices 30 in a geographic area and can determine the perimeter of a geographic area, as well as identify and/or determine the position of desired objects in the geographic area, with the marking device. Each fixture 14 can store and/or save its position (e.g., in non-volatile memory). Once the position of the relevant objects in a geographic area are determined, the marking device and position devices 30 can be disposed in another geographic area such that a user can repeat determine the position of additional fixtures/objects.

System 10 can be configured to operate in multiple geographic areas. For example, positioning devices 30, fixtures 14, control device 18, and/or a marking device can be used to determine the position of fixtures 14 in multiple geographic areas (e.g., multiple rooms in a house). In some embodiments, after the position of four fixtures 14 have been determined, fixtures 14 can operate similarly to positioning devices 30 to determine the position of other fixtures 14. Positioning devices 30 and/or control device 18 can be configured such that if positioning devices 30 can no longer interface with devices in a prior geographic area (e.g., due to a large distance), positioning devices 30 and/or control device 18 can notify a user (e.g., by producing a sound (e.g., an alarm), flashing a light, etc.). Positioning devices 30 and/or control device 18 can also be configured such that if positioning devices 30 are able to interface with devices in a prior or current geographic area, positioning devices 30 and/or control device 18 can notify a user (e.g., by producing a sound (e.g., an alarm), flashing a light, etc.).

As previously discussed, system 10 can be configured to display a map depicting fixtures 14, control device 18, positioning devices 30, and/or any other objects identified by the marking device. Information relating to fixtures 14, control device 18, positioning devices 30, and/or any other objects identified by the marking device can also be displayed (e.g., brightness of a light, color of a light, temperature of a light, timing information, groupings of fixtures, direction/orientation of fixtures, volume of a speaker, and the like). Control device 18 can also be configured to indicate whether a device with which control device 18 is interfaced is defective (e.g., when a light requires replacement). For example, each fixture can comprise an identifier. Control device 18, positioning devices 30, and/or fixtures 14 can be configured to determine when a fixture 14 with a given identifier is not present (e.g., does not appear on a map displayed by control device 18). A user can select an icon on the map (e.g., by touching a screen of control device 18) to adjust a device. In some embodiments, fixtures 14 can be assigned a unique building or room identifier. Control device 18 can be configured such that only certain users can see and/or adjust fixtures 14 (e.g., by requiring an access code in order to see and/or adjust fixtures 14, by encrypting positioning/display information such that only certain users can see and/or adjust fixtures 14, and the like). In some embodiments, control device 18 can be configured to permit a user to drag an icon to another position within the geographic area (e.g., to represent that a fixture is disposed in a new location within the geographic area). Similarly, control device 18 can be configured to permit a user to create a map (e.g., defining fixture positions, defining a perimeter of a geographic area, etc.). In some embodiments, a first fixture can be configured to interface with a second fixture such that a user can replicate an adjustment of the first fixture to the second fixture (e.g., such that the second fixture can comprise the same or similar characteristics as the first fixture (e.g., the same orientation, color, brightness, volume, etc.)).

Some embodiments of the present methods comprise disposing four positioning devices in a geographical area (e.g., positioning devices 30); using the positioning devices, determining a position of at least one fixture (e.g., fixture 14); displaying a map of the position of the at least one fixture on a control device (e.g., control device 18); and adjusting the at least one fixture using the map displayed on the control device. In some embodiments, the at least one fixture is a light fixture. In some embodiments, the method further comprises adjusting a brightness and/or a color of the light fixture with the control device. In some embodiments, the method further comprises replicating an adjustment of the at least one fixture to another fixture.

All of the systems and methods disclosed and claimed herein can be made and executed without undue experimentation in light of the present disclosure. While the systems and methods of this invention have been described in terms of preferred embodiments, it will be apparent to those of skill in the art that variations may be applied to the systems and methods and in the steps or in the sequence of steps of the systems and method described herein without departing from the concept, spirit and scope of the invention. In addition, modifications may be made to the disclosed systems and methods and components may be eliminated or substituted for the components described herein where the same or similar results would be achieved. All such similar substitutes and modifications apparent to those skilled in the art are deemed to be within the spirit, scope, and concept of the invention as defined by the appended claims.

1. A system for remotely adjusting a fixture comprising:
at least one fixture;
a control device configured to interface with the at least one fixture and further configured to:
determine a position of the at least one fixture;
provide a display of the at least one fixture on a map; and
permit a user to adjust the at least one fixture with the display.

2. The system of claim 1, where the system further comprises:
a first positioning device;
a second positioning device;
a third positioning device; and
a fourth positioning device;
where the first positioning device, the second positioning device, the third positioning device, and the fourth positioning device are configured to interface with the control device such that the control device can determine the position of the at least one fixture.

3. The system of claim 2, where the at least one fixture comprises an identifier and the control device is configured to identify the at least one fixture with respect to other objects based on the identifier.

4. The system of claim 1, where the system is configured to determine the position of the at least one fixture with GPS, WiFi, Bluetooth, radio frequency identification, ultra wide band, radio, sound, ultrasound, Zigbee, light, infrared, or a combination thereof.

5. The system of claim 1, where the at least one fixture is at least one of audio-visual equipment, a light, a television, a radio, a speaker, a sprinkler, an alarm system, and other suitable devices.

6. The system of claim 1, further comprising:
a plurality of fixtures, the control device configured to determine a position of each fixture with respect to a position of other fixtures.

7. The system of claim 1, where the control device is at least one of a computer, mobile phone, and a tablet.

8. The system of claim 1, where the map is further configured to display a position of the control device.

9. The system of claim 1, where the control device is further configured to determine an orientation of the at least one fixture.

10. The system of claim 1, where the control device is configured to permit a user to adjust the position and the orientation of the at least one fixture.

11. The system of claim 1, where the map displays a geographic area in which the system is located.

12. The system of claim 1, where when the at least one fixture is a light, the control device is configured to permit a user to adjust brightness of the light.

13. The system of claim 1, where when the at least one fixture is a light, the control device is configured to permit a user to adjust a color of the light.

14. The system of claim 6, where the control device is configured to determine the position of the at least one fixture based on at least one of WiFi, GPS, radio frequency identification, Bluetooth, radio, sound, ultrasound, light, Zigbee, and ultra wide band.

15. The system of claim 6, where a first fixture in the plurality of fixtures is configured to interface with a second fixture in the plurality of fixtures such that a user can replicate an adjustment of the first fixture to the second fixture.

16. A method for remotely adjusting a fixture comprising:
disposing four positioning devices in a geographical area;
using the positioning devices, determining a position of at least one fixture;
displaying a map of the position of the at least one fixture on a control device; and
adjusting the at least one fixture using the map displayed on the control device.

17. The method of claim 16, where the at least one fixture is a light fixture.

18. The method of claim 17, further comprising:
adjusting a brightness of the light fixture with the control device.

19. The method of claim 17, further comprising:
adjusting a color of the light fixture with the control device.

20. The method of claim 16, further comprising:
replicating an adjustment of the at least one fixture to another fixture.
